(19) United States
(12) Patent Application Publication
(10) Pub. No.: US 2009/0287687 A1
(43) Pub. Date: Nov. 19, 2009

(54) SYSTEM AND METHOD FOR RECOMMENDING VENUES AND EVENTS OF INTEREST TO A USER

(76) Inventors: GIANNI MARTIRE, Englewood Cliffs, NJ (US); Chris Mirabile, New York, NY (US)

Correspondence Address: PERKINS COIE LLP, P.O. BOX 1208, SEATTLE, WA, 98111-1208, US

(21) Appl. No.: 12/423,687

(22) Filed: Apr. 14, 2009

Related U.S. Application Data
(60) Provisional application No. 61/044,574, filed on Apr. 14, 2008.

(51) Int. Cl. G06F 17/30

(52) U.S. Cl. 707/5; 707/E17.084

(57) ABSTRACT

A system and method is disclosed for recommending venues and events to individual users using a combination of collaborative filtering and integrating social behavioral pattern data gathered and computed via an electronic device. The system and method of the present invention is configured to receive data based on users' past, present and future social activity and interests, which are submitted to the system via an electronic device. When a new data item is made available from sources such as a mobile device, social networks or GPS systems, the system and method analytically breaks down the new item data, compares it to ascertained attributes of item data that a user (i.) indicated interest to in the past, (ii.) has a friend or related network of users that indicated interest in the venue or in an event in the past, and (iii.) indicated interest in the event or venue based upon general social statistics such as male to female ratio, age, and other demographics gathered and computed by the system. The system generates the recommendations using a previously-generated table which maps items to lists of “similar” items thereby making a audience-specific, time-specific and location-specific social recommendation.

### CROSS-REFERENCE TO RELATED APPLICATIONS

This application claims the benefit of U.S. Provisional Application No. 61/044,574, entitled “COLLEGE HOTLIST”, filed Apr. 14, 2008 and is hereby incorporated by reference.

### BACKGROUND OF INVENTION

1. FIELD OF INVENTION (TECHNICAL FIELD)

The invention relates to an intelligent technique for learning user interests based on user actions and then applying the learned knowledge to rank, recommend, and/or filter new items based on the level of interest to a user. More particularly the invention relates to an automated, personalized information learning and recommendation engine for recommending venues and events to individual users using a combination of collaborative filtering and integrating social behavioral pattern data gathered and computed via an electronic device.

2. DESCRIPTION OF RELATED ART

Recommendation systems are programs that suggest items of potential interest to a person—such as television programs, music, and retail products—given some information about the person's interests.

Often, recommendation systems are implemented using collaborative filtering techniques, where a person's interests are determined (filtered) based on the interests of many other people (by collaboration). Collaborative filtering systems generally operate in two steps: First, identify people who share the same interests as the target user—as indicated by rating patterns or past purchase activity. Then, using the ratings from those like-minded people, recommendations are made to the user. Some shortcomings of naive collaborative filtering include: inadequate overlap of interests between the user and the group (a.k.a., the “sparsity problem”), ineffective if there is not enough rating or purchase information available for new items, potential privacy concerns of having purchase or preference information stored on third-party servers, and the potential for having recommendations influenced by the artificial inflation or deflation of ratings (spoofing).

Another approach to recommendation systems is content-based. In this approach, the content or other characteristics of the items themselves are used to gage a person's interest in new items. For example, knowledge of genres, artists, actors, directors, writers, MPAA-type ratings, cost, and production date of previously consumed (viewed, purchased, listened to) items is used to predict additional items of interest. These techniques depend on the ratings or past behavior of an individual user—not on the preferences of a group. Shortcomings of this approach can be: need for user to explicitly enter preference/profile information and difficulties in extracting good features for describing items.

### GLOSSARY OF TERMS

Clustering: In certain embodiments, clustering is the process of partitioning items into groups of similar items.

Clustering Decision Tree: In certain embodiments, a clustering decision tree is a decision tree in which leaves denote clusters of similar examples. In certain embodiments, the criteria used to determine node splitting in the clustering decision tree is similarity of cluster centroids, rather than a metric related to information gain.

Data Sources: In certain embodiments, are web sites, online databases, private databases, printed item descriptions, electronic files containing item descriptions.

Items: In certain embodiments, items are venue ratings, venue type, venue qualities event type, crowd rating, user-defined interests, male/female personality & aesthetic preferences, location, demographic traits, friends' social interests, attendance statistics, and the like.

Targeted Advertising: In certain embodiments, targeted advertising consists of information about products or services designed to appeal to specific groups of viewers and delivered to reach those viewers.

Social Behavioral Pattern: Data that identifies social communication and social interaction patterns between users, friends, and social networks.

### SUMMARY OF THE INVENTION

In an exemplary embodiment of the present invention, a system and method represents one or more items of interest to a user. The representation of an item of interest is presented as a vector consisting of N distinct attributes representing content or features that collectively describe the item. The relevance of an item, a quantitative estimate of a user's interest in the item, can be determined by analyzing the users social trends reviews in addition to the users' friend's social trends/reviews.

A system and method is disclosed for recommending venues and events to individual users using a combination of collaborative filtering and integrating social behavioral pattern data gathered and computed via an electronic device. The system and method of the present invention is configured to receive data based on users' past, present and future social activity and interests, which are submitted to the system via an electronic device. When a new data item is made available from sources such as a mobile device, social networks or GPS systems, the system and method analytically breaks down the new item data, compares it to ascertained attributes of item data that a user (i.) indicated interest to in the past, (ii.) has a friend or related network of users that indicated interest in the venue or in an event in the past, and (iii.) indicated interest in the event or venue based upon general social statistics such as male to female ratio, age, and other demographics gathered and computed by the system. The similarities reflected by the table are based on the collective interests of the community of users. For example, in one embodiment, the similarities are based on correlations between common friends of the user (e.g., Venue A and Venue B are similar because a relatively large portion of the users' friends that frequent/highly rate Venue A also frequent/highly rate Venue B). The table also includes rankings to indicate degrees of similarity between individual items. After factors such as venue and event characterizations, in addition to users' personal social patterns and the patterns of their networks and friends are computed, the system produces numeric ranking of the new item data dynamically, and without subsequent user input, or data manipulation by item data deliverers, delivering a tailored social recommendation that is audience-specific, time-specific and location-specific. The system generates the recommendations using a previously-generated table which maps items to lists of “similar” items thereby making a audience-specific, time-specific and location-specific social recommendation.

### BRIEF DESCRIPTION OF THE DRAWINGS

FIG. 1 is a flowchart illustrating the steps of recommending an item to a user according an embodiment of the present invention.

FIG. 2 is a screenshot illustrating the list of audience-specific, time-specific and location-specific social recommendations generated by the system.

FIG. 3 is a screenshot displaying the feedback engine the system uses to learn if the user liked or disliked the past social recommendation.

FIG. 4 is a screenshot displaying the method the system uses to gather social statistics and user information from social networks.

FIG. 5 is a screenshot displaying the method the system uses to gather social statistics and user information from mobile networks.

FIG. 6 is a list illustrating the available data points the system uses to make social recommendation to users. This data includes but is not limited to explicit and implicit user preferences, the system's dynamic characterization of a user, a venue's or event's characterization and social feedback from the users friends.

### DETAILED DESCRIPTION OF THE INVENTION

The following description is intended to convey an understanding of the invention by providing a number of specific embodiments and details involving various applications of the invention. It is understood, however, that the invention is not limited to these embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The following disclosure considers in detail potential applications for embodiments of the present invention, including, by way of non-limiting examples, systems and methods for providing personalized social recommendations in the areas of social and mobile networking.

In the past, people had to make social decisions based a very limited amount of data. For example, if someone was interested in finding a fun venue or event in the area, the individual had to ask his colleagues, his friends, or consult the Internet for feedback before making a social decision. The problem with such methods is that they are extremely time consuming and very subjective to what other people think. These limitations often result in negative utility for the individual, as there are too many unknown variables and lack of data.

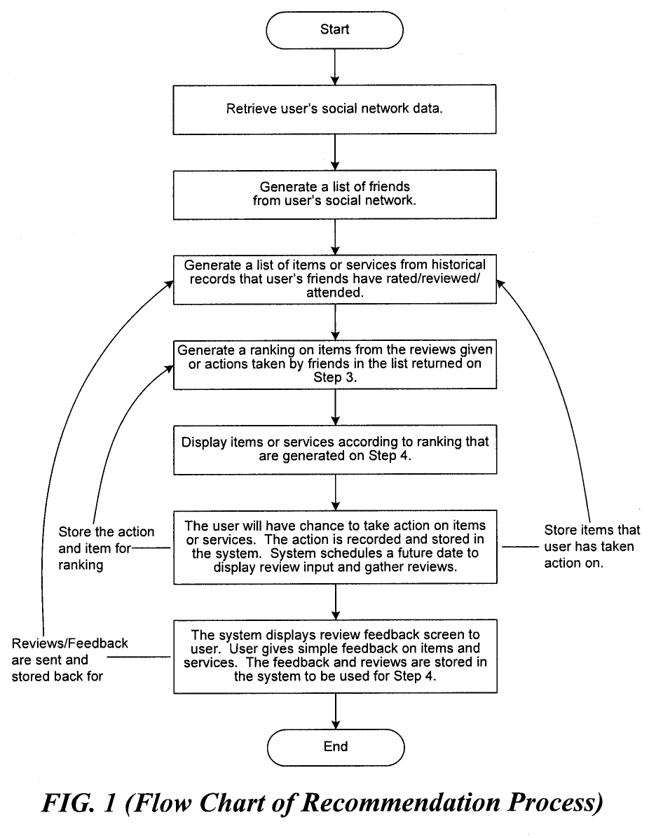

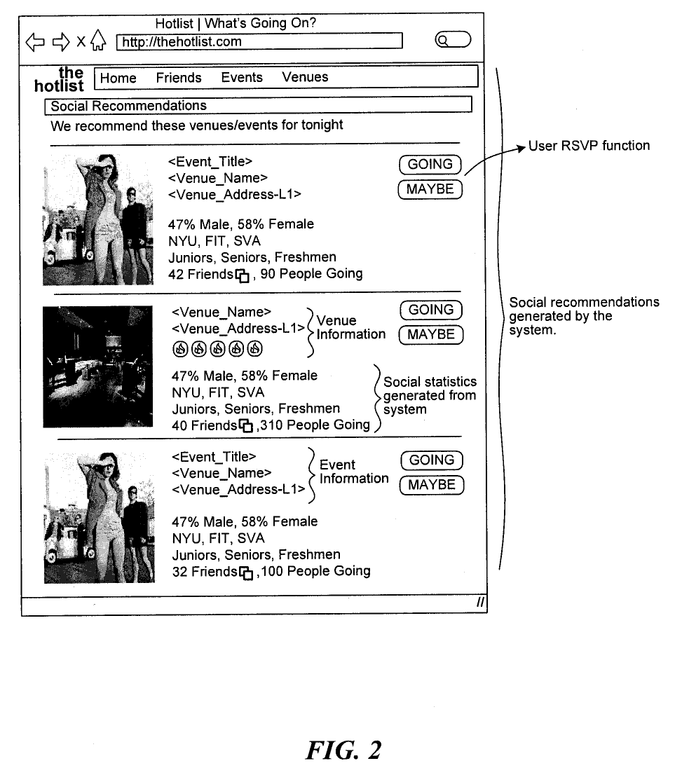

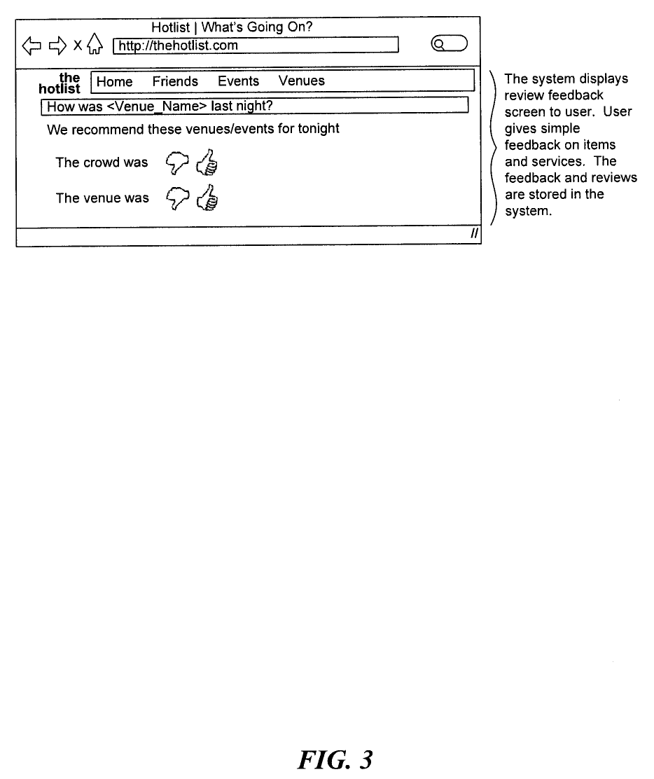

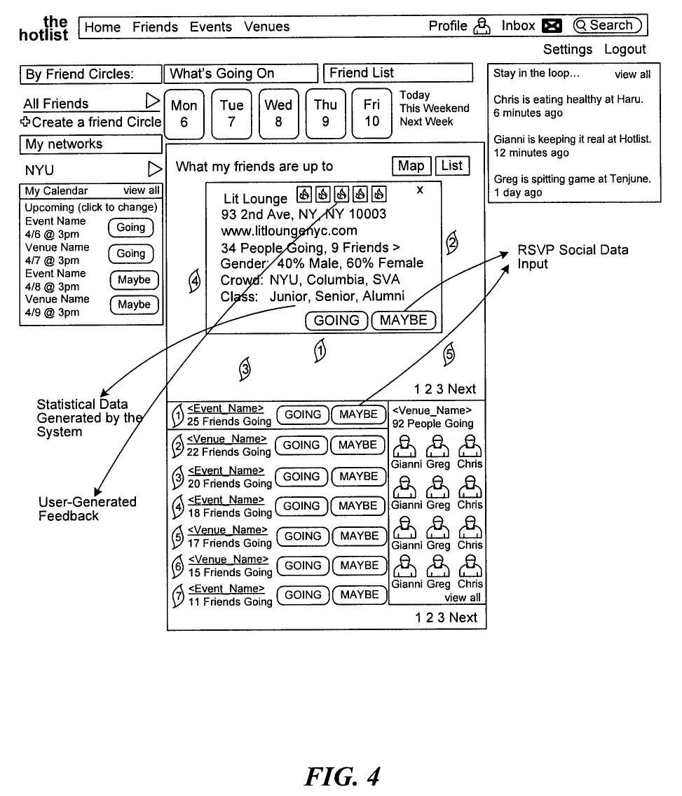

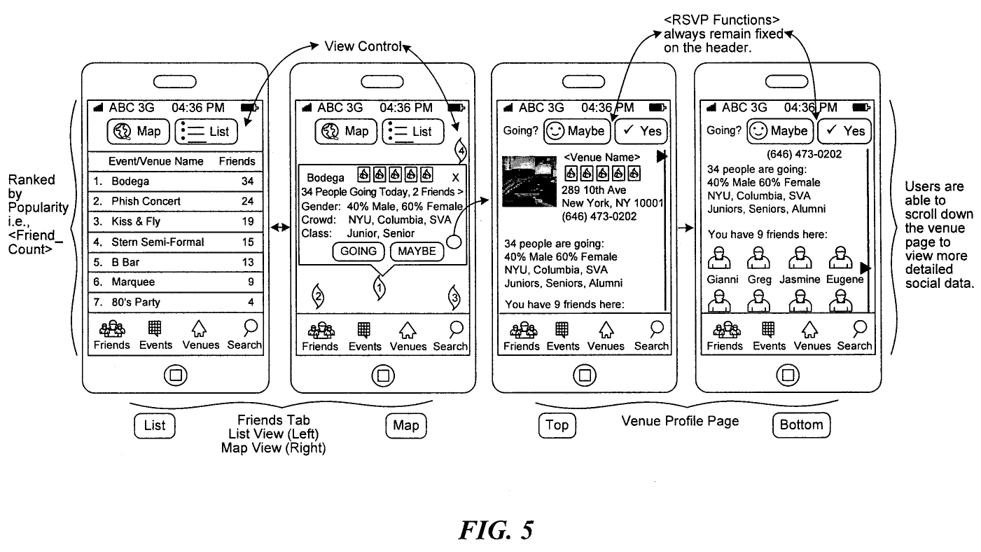

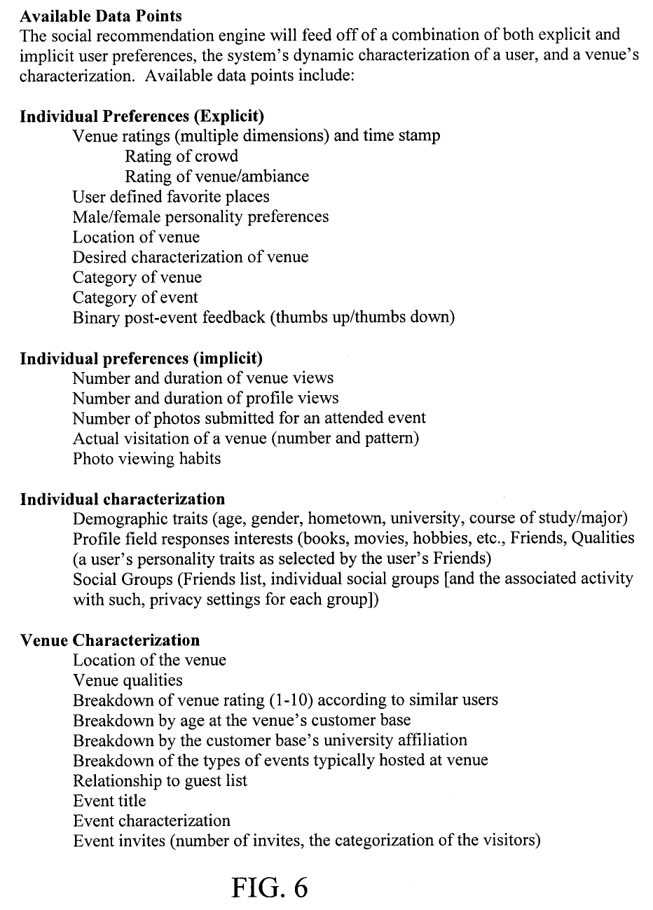

FIG. 1 The following system and method will improve this process by analyzing social trends, aggregating what the users friends are doing and enjoy to do, and provide the user with a personalized social recommendation FIG. 2 based on all of these factors FIG. 6. The system will incorporate basic machine learning components in which the system asks the user for feedback on a past social recommendation FIG. 3. Once the user provides this feedback, the system will calculate possible factors to why the user liked/disliked the recommendation FIG. 6. This is based but not limited to the user's feedback on the location of the social event but also to what the user thought about the crowd at the event or venue via a simple thumbs up, thumbs down feedback system FIG. 3. Once the system has enough data points from each user, the recommendations will become increasingly more accurate as the system may recommend a venue on a Friday but not on a Saturday as the crowd may not be to the user's liking based on the aggregated statistical data collected by system from other users who attended the venue. This data is collected via the system's location aware apparatus FIG. 4. This social apparatus collects data via social networks FIG. 4 and mobile electronic devices FIG. 5. This data is composed of user-generated data that is collected via mobile GPS networks in addition to user-imputed data.

The present invention teaches a variety of techniques and mechanisms for recommending venues and events to individual users using a combination of collaborative filtering and integrating social behavioral pattern data gathered and computed via an electronic device. FIG. 1 The system and method of the present invention is configured to receive data based on users' past, present and future social activity and interests, which are submitted to the system via an electronic device FIG. 5, FIG. 4. When a new data item is made available from sources such as a mobile device, social networks or GPS systems, the system and method analytically breaks down the new item data, compares it to ascertained attributes of item data that a user (i.) indicated interest to in the past, (ii.) has a friend or related network of users that indicated interest in the venue or in an event in the past, and (iii.) indicated interest in the event or venue based upon general social statistics such as male to female ratio, age, and other demographics gathered and computed by the system. The system generates the recommendations using a previously-generated table which maps items to lists of “similar” items. The similarities reflected by the table are based on the collective interests of the community of users. For example, in one embodiment, the similarities are based on correlations between common friends of the user (e.g., Venue A and Venue B are similar because a relatively large portion of the users' friends that frequent/highly rate Venue A also frequent/highly rate Venue B). The table also includes rankings to indicate degrees of similarity between individual items. After factors such as venue and event characterizations, in addition to users' personal social patterns and the patterns of their networks and friends are computed, the system produces numeric ranking of the new item data dynamically, and without subsequent user input, or data manipulation by item data deliverers, delivering a tailored social recommendation that is audience-specific, time-specific and location-specific FIG. 2. An embodiment is disclosed for learning users' social interests based on user actions and then applying the learned knowledge to rank, recommend, and/or filter items. FIG. 6 The embodiment may also be used for automated personalized information learning, recommendation, and/or filtering systems and third party applications via any electronic device. The embodiment may also be structured to generate venue and event descriptions, learn venues and events of interest, learn terms that effectively describe the items, cluster similar items in a compact data structure, and then use the structure to rank new offerings to improve the method of how a user makes a audience-specific, time-specific and location-specific social recommendation FIG. 2.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A computer implemented method for recommending venues and events of interest to a user, comprising:
retrieving social network information for a first user from a plurality of social networking platforms;
generating a first list of friends associated with said first user from said social network information;
utilizing historical records associated with members of said first list of friends, generating a second list including items and/or services that said members of said first list of friends have rated, reviewed, and/or attended;
ranking said second list;
displaying said second list to said first user according to said ranking.

2. A computer implemented method as recited in claim 1, further comprising tracking and storing action taken by said first user in response to said second list.

3. A computer implemented method as recited in claim 2, further comprising, receiving feedback from said first user regarding results of said action taken by said first user.
